(19) United States
(12) Patent Application Publication
(10) Pub. No.: US 2017/0357771 A1
(43) Pub. Date: Dec. 14, 2017

(54) PATIENT RISK SCORING & EVALUATION SYSTEM

(71) Applicant: Cardiac Pacemakers, Inc., St. Paul, MN (US)

(72) Inventors: Patrick Connolly, Galway (IE); Maureen C. Cavalerie, London (GB); Nicolaus Wilson, Paris (FR); Barry O'Grady, Galway (IE)

(21) Appl. No.: 15/619,344

(22) Filed: Jun. 9, 2017

Related U.S. Application Data
(60) Provisional application No. 62/348,649, filed on Jun. 10, 2016.

(51) Int. Cl. G06F 19/00

(52) U.S. Cl. CPC G06F 19/3431

(57) ABSTRACT

A method of facilitating health of a patient includes determining, based on patient information, a risk score. The patient information includes clinical information and at least one of psychosocial information, experiential information, relational information, preferential information, demographic information, barrier information, and compliance information. The method further includes identifying a number of risk factors that influence the risk score; determining a level of influence that each risk factor has on the risk score; and causing a display device to present a representation of the risk score.

### CROSS-REFERENCE TO RELATED APPLICATION

This application claims priority to Provisional Application No. 62/348,649, filed Jun. 10, 2016, which is herein incorporated by reference in its entirety.

### TECHNICAL FIELD

The present disclosure relates to systems and methods for facilitating management of the health of a patient. More specifically, the disclosure relates to systems and methods for determining, based on various types of information, a risk score associated with a patient.

### BACKGROUND

Costs for healthcare systems to monitor and treat patients with chronic conditions such as heart failure are significant and continue to rise. Unplanned readmissions to hospital may be particularly expensive. In order to reduce hospital utilization patients may be cared for at home by primary care physicians, family members, and/or caregivers with support from specialist services found within a hospital.

### SUMMARY

In an Example 1, a method of facilitating health of a patient, the method comprising: determining, based on patient information, a risk score, the patient information comprising clinical information and at least one of psychosocial information, experiential information, relational information, preferential information, demographic information, barrier information, and compliance information; identifying a plurality of risk factors that influence the risk score; determining a level of influence that each of the plurality of risk factors has on the risk score; and causing a display device to present a representation of the risk score.

In an Example 2, the method of Example 1, wherein the representation of the risk score includes a representation of the level of influence of each of the plurality of risk factors.

In an Example 3, the method of either of Examples 1 or 2, further comprising: receiving additional patient information and/or user input; and determining, based on the additional patient information and/or the user input, an updated risk score; and causing the display device to present a representation of the updated risk score.

In an Example 4, the method of any of Examples 1-3, further comprising generating, based on at least one of the risk score and the updated risk score, a recommendation, the recommendation comprising at least one of a care team recommendation and a care plan recommendation.

In an Example 5, the method of any of Examples 1-4, the risk score comprising a score corresponding to at least one of a risk of admission, a risk of readmission, a risk of hospital utilization, a risk of high care cost, a risk of injury, a risk of decompensation, a risk of noncompliance, a risk of exacerbation, and a risk of an adverse event.

In an Example 6, the method of any of Examples 1-5, wherein determining the risk score comprises applying a statistical regression model to the patient information.

In an Example 7, the method of any of Examples 1-6, wherein the representation of the risk score comprises a risk indicator, the risk indicator comprising at least one indication component, wherein a characteristic of the at least one indication component corresponds to at least one of the plurality of risk factors.

In an Example 8, the method of Example 7, further comprising: causing the display device to present a selectable option for reducing the risk score; receiving, via a user input device, a user selection of the selectable option; facilitating, in response to receiving the user selection of the selectable option, execution of a care service; determining that the care service has been completed; determining, based on determining that the care service has been completed, an updated risk score; and causing the display device to present a representation of the updated risk score.

In an Example 9, the method of Example 8, the care service comprising an education module, and wherein determining that the care service has been completed comprises determining that the patient has completed the education module.

In an Example 10, the method of either of Examples 8 or 9, wherein causing the display device to present a representation of the updated risk score comprises: assigning, based on the risk score, a first value of the characteristic of a first indication component, wherein causing the display device to present a representation of the risk score comprises causing the display device to present the first indication component having the first value of the characteristic; and assigning, based on the updated risk score, a second value of the characteristic of the first indication component, wherein causing the display device to present a representation of the updated risk score comprises causing the display device to present the first indication component having the second value of the characteristic.

In an Example 11, the method of Example 10, wherein causing the display device to present a representation of the updated risk score further comprises: assigning, based on the risk score, a third value of the characteristic of a second indication component, wherein causing the display device to present a representation of the risk score comprises causing the display device to present the second indication component having the third value of the characteristic.

In an Example 12, the method of Example 11, wherein the characteristic comprises color and/or activation state.

In an Example 13, a system for facilitating health of a patient, the system comprising: a display device; at least one processor; and one or more computer-readable media having computer-executable instructions embodied thereon that, when executed by the at least one processor, cause the at least one processor to instantiate at least one program component, the at least one program component comprising a risk analysis component configured to: determine, based on patient information, a risk score, the patient information comprising clinical information and at least one of psychosocial information, experiential information, relational information, preferential information, demographic information, barrier information, and compliance information; identify a plurality of risk factors that influence the risk score; determine a level of influence that each of the plurality of risk factors has on the risk score; and cause the display device to present a representation of the risk score.

In an Example 14, the system of Example 13, further comprising: a care team component configured to generate, based on at least one of the risk score and the updated risk score, a care team recommendation; and/or a care planning component configured to generate, based on at least one of the risk score and the updated risk score, a care plan recommendation.

In an Example 15, the system of either of Examples 13 or 14, the risk score comprising a score corresponding to at least one of a risk of admission, a risk of readmission, a risk of hospital utilization, a risk of high care cost, a risk of injury, a risk of decompensation, a risk of noncompliance, a risk of exacerbation, and a risk of an adverse event.

In an Example 16, a method of facilitating health of a patient, the method comprising: determining, based on patient information, a risk score, the patient information comprising clinical information and at least one of psychosocial information, experiential information, relational information, preferential information, demographic information, barrier information, and compliance information; identifying a plurality of risk factors that influence the risk score; determining a level of influence that each of the plurality of risk factors has on the risk score; and causing a display device to present a representation of the risk score.

In an Example 17, the method of Example 16, wherein the representation of the risk score includes a representation of the level of influence of each of the plurality of risk factors.

In an Example 18, the method of Example 16, further comprising: receiving additional patient information and/or user input; and determining, based on the additional patient information and/or the user input, an updated risk score; and causing the display device to present a representation of the updated risk score.

In an Example 19, the method of Example 16, further comprising generating, based on at least one of the risk score and the updated risk score, a recommendation, the recommendation comprising at least one of a care team recommendation and a care plan recommendation.

In an Example 20, the method of Example 16, the risk score comprising a score corresponding to at least one of a risk of admission, a risk of readmission, a risk of hospital utilization, a risk of high care cost, a risk of injury, a risk of decompensation, a risk of noncompliance, a risk of exacerbation, and a risk of an adverse event.

In an Example 21, the method of Example 16, wherein determining the risk score comprises applying a statistical regression model to the patient information.

In an Example 22, the method of Example 16, wherein the representation of the risk score comprises a risk indicator, the risk indicator comprising at least one indication component, wherein a characteristic of the at least one indication component corresponds to at least one of the plurality of risk factors.

In an Example 23, the method of Example 16, further comprising: causing the display device to present a selectable option for reducing the risk score; receiving, via a user input device, a user selection of the selectable option; facilitating, in response to receiving the user selection of the selectable option, execution of a care service; determining that the care service has been completed; determining, based on determining that the care service has been completed, an updated risk score; and causing the display device to present a representation of the updated risk score.

In an Example 24, the method of Example 23, the care service comprising an education module, and wherein determining that the care service has been completed comprises determining that the patient has completed the education module.

In an Example 25, the method of Example 23, wherein causing the display device to present a representation of the updated risk score comprises: assigning, based on the risk score, a first value of the characteristic of a first indication component, wherein causing the display device to present a representation of the risk score comprises causing the display device to present the first indication component having the first value of the characteristic; and assigning, based on the updated risk score, a second value of the characteristic of the first indication component, wherein causing the display device to present a representation of the updated risk score comprises causing the display device to present the first indication component having the second value of the characteristic.

In an Example 26, the method of Example 25, wherein causing the display device to present a representation of the updated risk score further comprises: assigning, based on the risk score, a third value of the characteristic of a second indication component, wherein causing the display device to present a representation of the risk score comprises causing the display device to present the second indication component having the third value of the characteristic.

In an Example 27, the method of Example 25, wherein the characteristic comprises color and/or activation state.

In an Example 28, a system for facilitating health of a patient, the system comprising: a display device; at least one processor; and one or more computer-readable media having computer-executable instructions embodied thereon that, when executed by the at least one processor, cause the at least one processor to instantiate at least one program component, the at least one program component comprising a risk analysis component configured to: determine, based on patient information, a risk score, the patient information comprising clinical information and at least one of psychosocial information, experiential information, relational information, preferential information, demographic information, barrier information, and compliance information; identify a plurality of risk factors that influence the risk score; determine a level of influence that each of the plurality of risk factors has on the risk score; and cause the display device to present a representation of the risk score.

In an Example 29, the system of Example 28, further comprising: a care team component configured to generate, based on at least one of the risk score and the updated risk score, a care team recommendation; and/or a care planning component configured to generate, based on at least one of the risk score and the updated risk score, a care plan recommendation.

In an Example 30, the system of Example 28, the risk score comprising a score corresponding to at least one of a risk of admission, a risk of readmission, a risk of hospital utilization, a risk of high care cost, a risk of injury, a risk of decompensation, a risk of noncompliance, a risk of exacerbation, and a risk of an adverse event.

In an Example 31, the system of Example 28, wherein determining the risk score comprises applying a statistical regression model to the patient information.

In an Example 32, the system of Example 28, wherein the representation of the risk score comprises a risk indicator, the risk indicator comprising at least one indication component, wherein a characteristic of the at least one indication component corresponds to at least one of the plurality of risk factors.

In an Example 33, the system of Example 28, further comprising: causing the display device to present a selectable option for reducing the risk score; receiving, via a user input device, a user selection of the selectable option; facilitating, in response to receiving the user selection of the selectable option, execution of a care service; determining that the care service has been completed; determining, based on determining that the care service has been completed, an updated risk score; and causing the display device to present a representation of the updated risk score.

In an Example 34, one or more computer-readable media having computer-executable instructions embodied thereon that, when executed by the at least one processor, cause the at least one processor to instantiate at least one program component, the at least one program component comprising: a risk analysis component configured to: determine, based on patient information, a risk score, the patient information comprising clinical information and at least one of psychosocial information, experiential information, relational information, preferential information, demographic information, barrier information, and compliance information; identify a plurality of factors that influence the risk score; determine a level of influence that each of the plurality of factors has on the risk score; and cause the display device to present a representation of the risk score.

In an Example 35, the media of Example 34, the risk score comprising a score corresponding to at least one of a risk of admission, a risk of readmission, a risk of hospital utilization, a risk of high care cost, a risk of injury, a risk of decompensation, a risk of noncompliance, a risk of exacerbation, and a risk of an adverse event.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 is a block diagram depicting an illustrative system 100 for facilitating health management of a patient, in accordance with embodiments of the disclosure.

FIG. 2 is a block diagram depicting an illustrative computing device 200, in accordance with embodiments of the disclosure.

FIG. 3 is a block diagram depicting an illustrative system 100 for facilitating health management of a patient, in accordance with embodiments of the disclosure.

FIG. 4 is a block schematic diagram depicting an illustrative process for facilitating health management of a patient, in accordance with embodiments of the disclosure.

FIG. 5 is a flow diagram depicting an illustrative method of facilitating health management of a patient, in accordance with embodiments of the disclosure.

FIG. 6 is a flow diagram depicting another illustrative method of facilitating health management of a patient, in accordance with embodiments of the disclosure.

FIGS. 7 and 8 depict illustrative representations of risk scores associated with patients, in accordance with embodiments of the disclosure.

FIGS. 9A and 9B depict an illustrative risk indicator, in accordance with embodiments of the disclosure.

While the disclosed subject matter is amenable to various modifications and alternative forms, specific embodiments have been shown by way of example in the drawings and are described in detail below. The intention, however, is not to limit the disclosed subject matter to the particular embodiments described. On the contrary, the disclosure is intended to cover all modifications, equivalents, and alternatives falling within the scope of the disclosed subject matter as defined by the appended claims.

As the terms are used herein with respect to ranges of measurements (such as those disclosed immediately above), “about” and “approximately” may be used, interchangeably, to refer to a measurement that includes the stated measurement and that also includes any measurements that are reasonably close to the stated measurement, but that may differ by a reasonably small amount such as will be understood, and readily ascertained, by individuals having ordinary skill in the relevant arts to be attributable to measurement error, differences in measurement and/or manufacturing equipment calibration, human error in reading and/or setting measurements, adjustments made to optimize performance and/or structural parameters in view of differences in measurements associated with other components, particular implementation scenarios, imprecise adjustment and/or manipulation of objects by a person or machine, and/or the like.

Although the term “block” may be used herein to connote different elements illustratively employed, the term should not be interpreted as implying any requirement of, or particular order among or between, various blocks disclosed herein. Similarly, although illustrative methods may be represented by one or more drawings (e.g., flow diagrams, communication flows, etc.), the drawings should not be interpreted as implying any requirement of, or particular order among or between, various steps disclosed herein. Additionally, a “set,” “subset,” or “group” of items (e.g., inputs, algorithms, data values, etc.) may include one or more items, and, similarly, a subset or subgroup of items may include one or more items. A “plurality” means more than one.

### DETAILED DESCRIPTION

Embodiments include health management systems and methods that facilitate patient health management, prevention of patient health deterioration, prevention of patient adverse events, patient care planning and execution, and/or the like. Embodiments include a health management system configured to calculate a risk score associated with the patient; provide that risk score and an identification of factors influencing the score to a team of care providers and/or the patient. The risk score may correspond to a risk of an undesirable health-related event such as a hospital admission or readmission, an exacerbation or decompensation (e.g., in the case of a heart failure patient), and/or the like. Conventional risk assessment systems typically assess risk based on clinical information, but those systems generally are not configured to incorporate other types of risk factors that may arise from, for example, psychosocial information, experiential information, relational information, preferential information, demographic information, cultural information, and/or the like. Embodiments of the health management system described herein incorporate these types of information, which may facilitate determining a more accurate perception of a patient's risk, understanding various barriers to treatment that the patient may experience, and/or the like.

Conventional risk assessment systems also are not typically configured to notify a patient of the patient's risk score, and those that are configured to notify the patient of some adverse clinical determination typically simply notify the patient and/or instruct the patient to take certain steps to address an urgent situation. It may be beneficial to more effectively incentivize a patient to take more responsibility for his or her health. According to embodiments, the risk score and information associated therewith may be provided to a patient's access device (e.g., a mobile device), which may be configured to display a representation of the risk score and a selectable option that, upon selection by the patient, may result in facilitation of a care service that, upon completion, may facilitate improving the patient's risk score. A representation of the improved risk score may be displayed to the patient, providing the patient with tangible and relatively immediate feedback, reinforcing the benefit of the care service.

According to embodiments, providing a risk score to the members of a patient's care team may facilitate consistency (e.g., may facilitate reducing treatment variability) and coordinated care. Knowledge of the patient risk score and risk factors may enable a care team to design an appropriate care plan and to address the risk factors to prevent future adverse health events. Understanding the factors influencing the risk score may facilitate identifying an appropriate multidisciplinary team and referrals to additional care providers. For example, caregivers may use the risk score and risk factor information to design a follow-up plan, care plan, to determine the intensity of treatment required, to determine the level of patient education required, to determine the level of monitoring required, and/or the like. Risk scores may vary from patient to patient, as can the risk factors influencing the risk scores. The reason for a patient's risk score can be complex and multifactorial. Some patients may be at higher risk than others because they are in later stages of a disease or have multiple comorbidities. Some patients may be at higher risk than others because they live alone and/or are uneducated (or undereducated). Other patients may be at higher risk than others because they have lost confidence and have lost interest in self-managing their condition.

Embodiments of the health management system incorporate access to different databases or repositories containing different types of information, thereby facilitating increasingly accurate risk score calculations that take into account numerous aspects of a patient's condition, situation, preferences, values, culture, behaviors, and/or the like. For example, the health management system may receive information from one or more information sources that provide a patient's clinical information such as, for example, an electronic health record (EHR) system, and/or a personal health record (PHR) system. The system also may receive information from a Patient Relationship Management (PRM) system, which provides other types of information that may facilitate understanding an individual patient's risks and various factors that contribute to those risks. For example, the PRM system may provide psychosocial information, experiential information, relational information, preferential information, demographic information, cultural information, and/or the like. Embodiments of the PRM system may be used for documenting, planning and facilitating patient care episodes and/or patient interactions. For example, the PRM system (which may, in embodiments, be integrated with the health management system) may provide a PRM dashboard configured to present patient information, information about past interactions, previous efforts to follow-up on or reach out to a patient, and/or the like.

Embodiments of the health management system may facilitate user access to information from systems such as the EHR, PHR, and PRM systems by providing interfaces to those systems, by providing a query service that access those systems, by integrating those systems within the health management system, and/or the like. Embodiments of the health management system may implement guidelines and/or algorithms that enable it to provide healthcare providers with recommendations and/or prompts (health planning recommendations) to facilitate assembly of an appropriate patient care team and care plan based on the risk score calculated and risk factors identified. In embodiments, the system may generate a health care plan, identify members of an appropriate health care team, and/or the like. Embodiments may facilitate prioritization of treatment for patients and/or symptoms, thereby enabling workflow efficiencies.

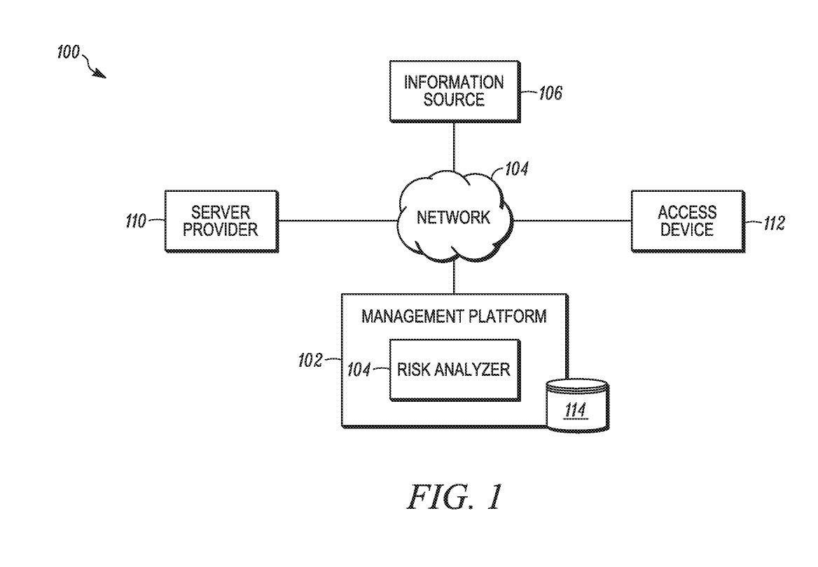

FIG. 1 is a block diagram depicting an illustrative system 100 for facilitating health management of a patient, in accordance with embodiments of the disclosure. As shown in FIG. 1, the illustrative health management system 100 includes a management platform 102 that accesses patient information, via a network 104, from an information source 106. The network 104 may be, or include, any number of different types of communication networks such as, for example, a short messaging service (SMS), a local area network (LAN), a wireless LAN (WLAN), a virtual LAN (VLAN), a wide area network (WAN), the Internet, a peer-to-peer (P2P) network, custom-designed communication or messaging protocols, and/or the like. The network 104 may include a combination of multiple networks. The information source 106 may include, for example, the Internet, an email provider, a website, an electronic health record (EHR), a patient relationship management (PRM) database, a user interface, and/or the like. According to embodiments, the management platform 102 implements a risk analyzer 108 that uses the accessed information to determine, and update, risk scores associated with patients. The management platform 102 may use the risk scores to facilitate any number of health-management related services such as, for example, by providing access to the risk scores and related information, and/or by utilizing a service provider 110, which a consumer of the services may access with an access device 112. Although depicted as a single component solely for the purposes of clarity of description, the access device 112 may actually refer to more than one access device 112.

The management platform 102, the information source 106, and/or the service provider 110 may be implemented using one or more servers, which may be, include, or may be included in, a computing device that includes one or more processors and a memory. The one or more servers, and/or any one or more components thereof, may be implemented in a single server instance, multiple server instances (e.g., as a server cluster), distributed across multiple computing devices, instantiated within multiple virtual machines, implemented using virtualized components such as virtualized processors and memory, and/or the like. According to embodiments, the management platform 102 may be referred to as a care management platform or care coordination platform.

The risk analyzer 108 obtains, copies, or otherwise accesses patient information from the information source 106. Although depicted as a single component solely for the purposes of clarity of description, the information source 106 may actually refer to more than one information source 106. The risk analyzer 108 may store the patient information, portions of the patient information, and/or information extracted from the patient information in a database 114. The database 114, which may refer to one or more databases, may be, or include, one or more tables, one or more relational databases, one or more multi-dimensional data cubes, and the like. Further, though illustrated as a single component, the database 114 may, in fact, be a plurality of databases 114 such as, for instance, a database cluster, which may be implemented on a single computing device or distributed between a number of computing devices, memory components, or the like.

In operation, the risk analyzer 108 accesses patient information (e.g., from the database 114, the information source 106, and/or the like) and, based on the patient information, determines a risk score associated with a patient. In embodiments, for example, the risk score may include a score corresponding to at least one of a risk of admission (e.g., to a hospital or other clinical setting), a risk of readmission (e.g., to a hospital or other clinical setting), a risk of hospital utilization (which may, e.g., include outpatient and/or emergency services), a risk of high care cost (e.g., defined with reference to a threshold established by a user, a machine-learning algorithm, etc.), a risk of injury (e.g., a risk of falling), a risk of decompensation (e.g., a risk of mental, emotional, and/or physical health deterioration due to an existing illness or condition), a risk of noncompliance (e.g., a risk of noncompliance with a medication prescription, an exercise regimen, etc.), a risk of exacerbation of the patient's illness and/or condition, a risk of an adverse event (e.g., a risk of an undesirable health event or episode, a risk of an accident resulting from an undesirable health event or episode, etc.), and/or the like. The risk analyzer 108 also may identify one or more risk factors that contribute to the risk score, a level of contribution of each of the factors, and/or the like. Risk factors may include any number of different types of factors such as, for example, presence of an illness; stage of an illness; historical treatment outcomes; certain types of comorbidity (e.g., heart failure with comorbid COPD); age; sex; activity level; family history; address (e.g., location of residence); discharge day (e.g., day of the week, date, etc.); number of hospital admissions; rate of hospital admissions (e.g., number of hospital admissions with a specified time period); date of last hospital admission; diet; ward or unit of hospital in which the patient is placed or from which the patient has been discharged; family (e.g., whether the patient is married, has children, etc.); patient satisfaction with caregivers; level of patient education; language barriers; and/or the like.

As used herein, the term “based on” is not meant to be restrictive, but rather indicates that a determination, identification, prediction, calculation, or the like, is performed by using, at least, the term following “based on” as an input. For example, a risk analyzer 108 that determines a risk score based on a particular piece of information may also base the same determination on another piece of information.

In embodiments, the risk analyzer 108 calculates a risk score based on a number of risk factors. The factors may be weighted to facilitate increased accuracy. In addition to using EHR information and PRM information, embodiments of the risk analyzer 108 may use various user inputs in determining a risk score. For example, a user (e.g., a patient, a caregiver, an insurer, etc.) may want to obtain a risk score associated with a risk of readmission, and may do so by providing a query to the health management system 100 as an input. In another instance, the user may wish to understand how the risk score might change for a patient if a certain risk factor was removed from the calculation, thereby enabling a user to better understand potential benefits of addressing a particular risk factor.

In embodiments, the risk scores, factors, contribution levels, and/or the like, may be used to facilitate one or more services. Aspects of the services may be provided using the management platform 102 and/or the service provider 110 which may include, for example, applications, service functions, or the like, that provide services for facilitating health management of patients. In embodiments, the service provider 110 may refer to one or more service providers 110 any one or more of which (and/or components thereof) may be integrated with the management platform 102. In embodiments, the services may include presenting risk scores and risk score information to users; providing care plan recommendations; generating care plans; identifying appropriate members of a care team; and/or the like. In embodiments, a patient's risk score and/or risk factor information may be used to calculate a payment to be received by a caregiver in return for providing the patient with care (e.g., outpatient care and/or inpatient care). In embodiments, the patient's risk score and/or risk factor information may be used to estimate the cost of care.

According to various embodiments, the management platform 102 may be configured to provide a risk score and risk score information to an access device 112 maintained by the patient. The access device 112 may be configured to present a representation of the risk score and/or the risk score information to the patient. In embodiments, for example, the access device 112 may instantiate a local client application that causes a representation of the risk score to be displayed on a display device associated with the access device 112. The risk score may include a risk indicator having at least one indication component, where a characteristic of the at least one indication component corresponds to at least one of the risk factors. A selectable option for reducing the risk score may also be presented such that, upon selection of the option by the patient, a care service may be provided to the patient (e.g., by the management platform 102, a service provider 110, etc.). Upon determining that the patient has completed the care service, the risk score may be updated to reflect that completion, and the representation of the risk score may be updated to reflect the updated risk score. That is, for example, if a risk factor is a lack of education, an education module may be provided to the patient and, upon completion of the education module, that completion may be factored in to a recalculated risk score, which may be determined, for example, by the risk analyzer 104. In this manner, embodiments may facilitate incentivizing a patient to engage in behaviors that may be advantageous for the patient's overall health and/or reducing risks of various types by providing the patient a visual representation of the patient's risk score that is understandable and that is accompanied by an opportunity, via the same user interface, to improve that score by invoking (and/or engaging in) a care service.

Various components depicted in FIG. 1 may operate together to form the health management system 100, which may be, for example, a computerized patient management and monitoring system. In embodiments, the system 100 may be designed to assist in monitoring the patient's condition, managing the patient's therapy, and/or the like. Patient health management and monitoring systems can provide large amounts of data about patients to users such as, for example, clinicians, patients, researchers, and/or the like. According to embodiments, the management platform 102 may additionally, or alternatively, be configured to provide reports to access devices 112, manage patient information, configure therapy regimens, manage/update device software, and/or the like.

The management platform 102 may be configured to perform security functions, verification functions, and/or the like. Due to potential risks associated with inaccurate calculation of risk scores and recommendations generated based thereon, it may be desirable for aspects of an at least partially automated system 100 to include safeguards such as, for example, verification of calculations, clinician oversight, and/or the like. For example, some types of users may be permitted, by the management platform 102, to have access to different amounts and/or types of information than other users. In embodiments, the management platform 102 may facilitate maintaining user profiles so that a user's role can be verified, thereby enabling the management platform 102 to customize the information available to a user. That is, for instance, an insurer may only be permitted to access certain portions of an EHR, PHR, PRM database, risk score, and/or the like, whereas a member of a patient's care team may be permitted to access more information.

In embodiments, the health management system 100 may be configured so that various components of the health management system 100 provide reporting to various individuals (e.g., patients and/or clinicians). For example, in embodiments, a user interface can be accessed via a device that is portable such that the user can use the system and have access to the system as they move about with in a hospital. In addition to forms of reporting including visual and/or audible information, the system 100 may also communicate with and/or reconfigure medical devices, which may be examples of information sources 106 and/or access devices 112. For example, if an access device 112 is part of a cardiac rhythm management system, the management platform 102 may communicate with the device 112 and reconfigure the therapy provided by the cardiac rhythm management system based on the patient information. In another embodiment, the management platform 102 may provide to the access device 112 recorded information, an ideal range for the information, a conclusion based on the information, a recommended course of action, and/or the like. This information may be displayed using a display device associated with the access device 112 for the patient to review or made available for the patient and/or clinician to review.

A variety of communication methods and protocols may be used to facilitate communication between management platforms 102, information sources 106, service providers 110, and/or access devices 112. For example, wired and wireless communications methods may be used. Wired communication methods may include, for example and without limitation, traditional copper-line communications such as DSL, broadband technologies such as ISDN and cable modems, and fiber optics, while wireless communications may include cellular, satellite, radio frequency (RF), Infrared, and/or the like.

For any given communication method, a multitude of standard and/or proprietary communication protocols may be used. For example and without limitation, protocols such as radio frequency pulse coding, spread spectrum, direct sequence, time-hopping, frequency hopping, SMTP, FTP, and TCP/IP may be used. Other proprietary methods and protocols may also be used. Further, a combination of two or more of the communication methods and protocols may also be used.

The various communications between the components of the system 100 may be made secure using several different techniques. For example, encryption and/or tunneling techniques may be used to protect data transmissions. Alternatively, a priority data exchange format and interface that are kept confidential may also be used. Authentication may be implemented using, for example, digital signatures based on a known key structure (e.g., PGP or RSA). Other physical security and authentication measures may also be used, such as security cards and biometric security apparatuses (e.g., retina scans, iris scans, fingerprint scans, veinprint scans, voice, facial geometry recognition, etc.). Conventional security methods such as firewalls may be used to protect information residing on one or more of the storage media of the advanced patient management system 100. Encryption, authentication and verification techniques may also be used to detect and correct data transmission errors.

In embodiments, varying levels of security may be applied to communications depending on the type of information being transmitted. For example, in embodiments, the management platform 102 (or other device) may be configured to apply stricter security measures to confidential health care information than to demographic information. Similarly, even more security may be applied to communications of information used for controlling therapy, adjudicating episodes, and/or the like. In embodiments, varying levels of security may be applied to communications depending on the type of user to whom the information is being communicated. Additionally, in embodiments, communications among the various components of the system 100 may be enhanced using compression techniques to allow large amounts of data to be transmitted efficiently.

The illustrative health management system 100 shown in FIG. 1 is not intended to suggest any limitation as to the scope of use or functionality of embodiments of the present disclosure. Neither should the illustrative system 100 be interpreted as having any dependency or requirement related to any single component or combination of components illustrated therein. Additionally, various components depicted in FIG. 1 may be, in embodiments, integrated with various ones of the other components depicted therein (and/or components not illustrated), all of which are considered to be within the ambit of the present disclosure.

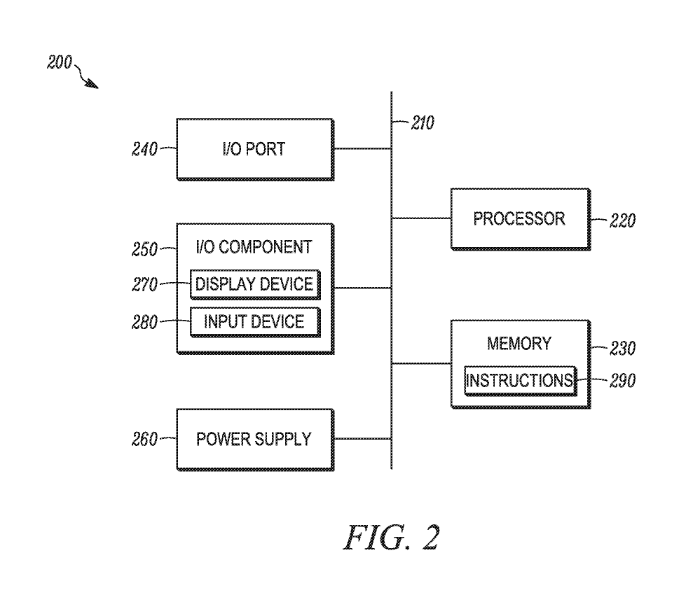

According to various embodiments of the disclosed subject matter, any number of the components depicted in FIG. 1 (e.g., the management platform 102, the information source 106, the service provider 110, and/or the access device 112) may be implemented on one or more computing devices. FIG. 2 is a block diagram depicting an illustrative computing device 200, in accordance with embodiments of the disclosure. The computing device 200 may include any type of computing device suitable for implementing aspects of embodiments of the disclosed subject matter. Examples of computing devices include specialized computing devices or general-purpose computing devices such “workstations,” “servers,” “laptops,” “desktops,” “tablet computers,” “hand-held devices,” “general-purpose graphics processing units (GPGPUs),” and the like, all of which are contemplated within the scope of FIGS. 1 and 2, with reference to various components of the system 100 and/or computing device 200.

In embodiments, the computing device 200 includes a bus 210 that, directly and/or indirectly, couples the following devices: a processor 220, a memory 230, an input/output (I/O) port 240, an I/O component 250, and a power supply 260. Any number of additional components, different components, and/or combinations of components may also be included in the computing device 200. The I/O component 250 may include a presentation component configured to present information to a user such as, for example, a display device 270, a speaker, a printing device, and/or the like, and/or an input device 280 such as, for example, a microphone, a joystick, a satellite dish, a scanner, a printer, a wireless device, a keyboard, a pen, a voice input device, a touch input device, a touch-screen device, an interactive display device, a mouse, and/or the like.

The bus 210 represents what may be one or more busses (such as, for example, an address bus, data bus, or combination thereof). Similarly, in embodiments, the computing device 200 may include a number of processors 220, a number of memory components 230, a number of I/O ports 240, a number of I/O components 250, and/or a number of power supplies 260. Additionally any number of these components, or combinations thereof, may be distributed and/or duplicated across a number of computing devices.

In embodiments, the memory 230 includes computer-readable media in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a computing device such as, for example, quantum state memory, and/or the like. In embodiments, the memory 230 stores computer-executable instructions 290 for causing the processor 220 to implement aspects of embodiments of system components discussed herein and/or to perform aspects of embodiments of methods and procedures discussed herein.

The computer-executable instructions 290 may include, for example, computer code, machine-useable instructions, and the like such as, for example, program components capable of being executed by one or more processors 220 associated with the computing device 200. Program components may be programmed using any number of different programming environments, including various languages, development kits, frameworks, and/or the like. Some or all of the functionality contemplated herein may also, or alternatively, be implemented in hardware and/or firmware.

The illustrative computing device 200 shown in FIG. 2 is not intended to suggest any limitation as to the scope of use or functionality of embodiments of the present disclosure. Neither should the illustrative computing device 200 be interpreted as having any dependency or requirement related to any single component or combination of components illustrated therein. Additionally, various components depicted in FIG. 2 may be, in embodiments, integrated with various ones of the other components depicted therein (and/or components not illustrated), all of which are considered to be within the ambit of the present disclosure.

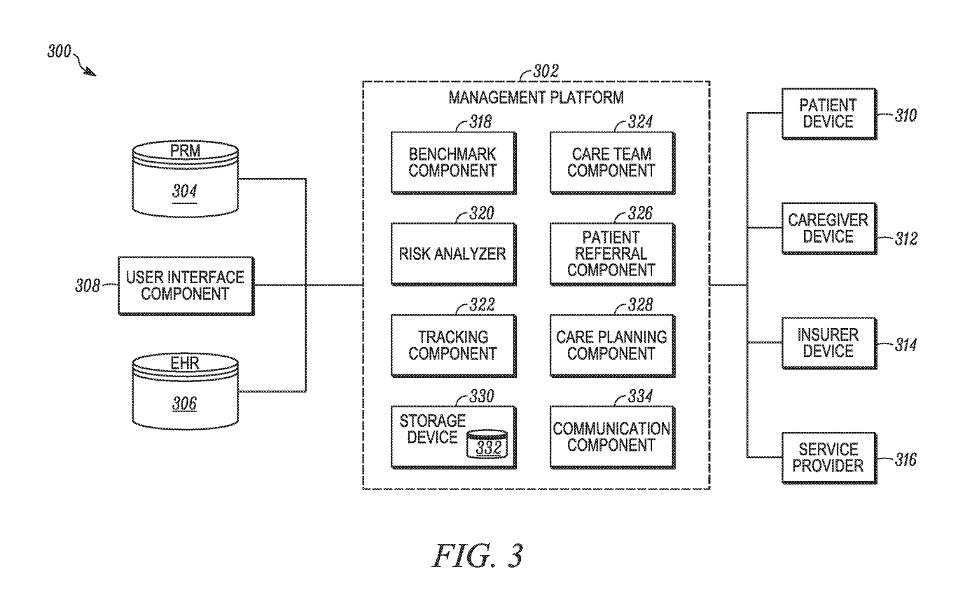

FIG. 3 is another block diagram depicting an illustrative health management system 300, in accordance with embodiments of the disclosure. As shown, the system 300 includes a management platform 302 (e.g., the management platform 102 depicted in FIG. 1) that is communicably coupled to information sources such as, e.g., a PRM database 304, an EHR database 306, and a user interface component 308. The management platform 302 is configured to receive patient information from the information sources 304, 306, and 308 (any one or more of which may be examples of the information source 106 depicted in FIG. 1).

In embodiments, the PRM database 304 may include any number of different types of information associated with a patient (generally information that is at least partially different than the clinical information available from the EHR database 306). For example, the PRM database 304 may include at least one of psychosocial information, experiential information, relational information, preferential information, demographic information, barrier information, and compliance information. In embodiments, the PRM database 304 includes, incorporates, or is coupled to modules that enable the gathering of PRM information. These information gathering modules may include, for example, software programs, data entry forms, and/or the like. According to embodiments, a remote patient monitoring module may be used to gather information such as, for example, by providing an interactive experience on a mobile device, obtaining information from a medical device, and/or the like.

An example of a data gathering module includes a barrier assessment module. A barrier assessment module may be used to gather information associated with barriers to treatment, improvement, recovery, etc. that a particular patient faces. That is, for example, a barrier assessment may be designed to identify challenges that exist for patients and their caregivers that make it difficult for the patient to maintain good health and/or that otherwise contribute to a patient's risk score. Barriers may include behavior (e.g., an unwillingness to see doctors, etc.); mental state (e.g., depression, a lack of trust for caregivers, etc.); family issues (e.g., divorce, responsibilities associated with caring for an ill family member, etc.); medication/procedure side-effects; financial situation (e.g., uninsured, underinsured, inability to pay for care services, etc.); education (e.g., lack of general education, lack of specific education related to the patient's health, etc.); language; culture (e.g., religious beliefs, cultural norms, etc.); and/or the like. A barrier assessment module may include a questionnaire that elicits answers that are used to identify patient risk factors. A patient satisfaction module may be used, in embodiments, to gather patient satisfaction information which may be used to identify risk factors such as a patient's confidence in a care team, a patient's willingness to engage with a care team, or a patient's activation level. According to embodiments, a barrier assessment may be performed by a patient or by a healthcare provider with a patient, and may be administered, for example, via a website, in person, on paper, on a computer, on a mobile device, and/or the like.

The EHR database 306 may be provided by an EHR system, integrated with the management platform 302, and/or the like. The EHR database 306 may include any number of different types of clinical information associated with any number of different patients. The clinical information may be provided to the database 306 using any number of different types of electronic medical record (EMR) reporting architectures, PHR systems, direct entry, and/or the like.

The management platform 302 also is communicably coupled to one or more access devices such as, for example, a patient device 310, a caregiver device 312, and an insurer device 314 (any one or more of which may be examples of the access device 112 depicted in FIG. 1). The management platform 302 may also be communicably coupled to a service provider 316 (e.g., the service provider 110 depicted in FIG. 1). The management platform 302 may be configured to provide risk scores and/or other information to the access devices 310, 312, and 314 and the service provider 316, and/or to receive information from the access devices 310, 312, and 314 and the service provider 316. In embodiments, a service provider may be, include, or be included within, a component of the management platform 302 in lieu of, or in addition to, the illustrated service provider 316. In embodiments, for example, the communication component 334, described below, may be used as a service provider.

The management platform 302 includes a benchmark component 318, a risk analyzer 320 (e.g., the risk analyzer 108 depicted in FIG. 1), a tracking component 322, a care team component 324, a patient referral component 326, and a care planning component 328. The benchmark component 318 may be configured to determine, based on population patient information, benchmark information. The benchmark information may include, for example, information about baseline risk scores, baseline risk score factors, baseline influence levels, and/or the like, and may be dynamically modified using machine-learning techniques.

The tracking component 322 may be configured to track risk score calculations and risk factor information. For example, the tracking component 322 may store each calculated risk score on a storage device 330 that may include a database 332. The tracking component 322 may associate a time stamp with each risk score calculation and risk factor identification, and index these (along with, in embodiments, other risk factor information) using the database 332. In this manner, a caregiver may be able to ascertain, (e.g., using a query) the time of the last update of a risk score and/or risk factor information. In embodiments, a time-stamped risk score may be included in a care plan created at, or near, the time of the risk score calculation.

In embodiments, the components 318-328 may be implemented in any combination of hardware, software, and/or firmware, and may be implemented, at least in part, by a controller, a processor, and/or the like (not shown). The management platform 302 may include any number of other components or combination of components including, for example, a security component, a user authorization component, a registration component, a software provisioning component, and/or the like.

The database 332 may be, be similar to, include, or be included within the database 114 depicted in FIG. 1. For example, the database 332 may include a number of databases such as, for example, a patient database, a population database, a medical database, a general database, and/or the like. The database 332 may include patient specific data, including risk scores, risk factors, care plans, care team identifications, and/or the like. According to embodiments, the database 332 may include non-patient specific data, such as data relating to other patients and population trends. The database 332 may record epidemic-class device statistics, patient statistics, data relating to staffing by health care providers, environmental data, pharmaceuticals, and/or the like. Embodiments of the database 332 may include clinical data relating to the treatment of diseases, historical trend data for multiple patients in the form of a record of progression of their disease(s) along with markers of key events, and/or the like. The database 332 may include non-medical data related to the patient. In embodiments, the database 332 may include external medical records maintained by a third party, such as drug prescription records maintained by a pharmacy, providing information regarding the type of drugs that have been prescribed for a patient.

In embodiments, the risk analyzer 320 may utilize patient information received from the information sources 304 and 306, queries (and/or other user input) received from the user interface component 308, and/or information from other relevant sources, to analyze information related to a patient, and provide predictive assessments of the patient's well-being. These predictive assessments may include risk scores. As indicated above, a risk score may include a numerical value corresponding to a risk of admission, a risk of readmission, a risk of hospital utilization, a risk of high care cost, a risk of injury, a risk of decompensation, a risk of noncompliance, a risk of exacerbation of the patient's illness and/or condition, a risk of an adverse event, and/or the like. In performing this analysis, the risk analyzer 320 may utilize information collected from a variety of sources, including patient specific physiological and subjective data, medical and historical records (e.g., lab test results, histories of illnesses, etc., drugs currently and previously administered, etc.), as well as information related to population trends.

In embodiments, the risk analyzer 320 may provide a diagnosis of patient health status and predicted trend based on present and recent historical data collected from a device as interpreted by a system of expert knowledge derived from working practices within clinics. For example, the risk analyzer 320 may perform probabilistic calculations using currently-collected information combined with regularly-collected historical information to predict patient health degradation.

In embodiments, the risk analyzer 320 may conduct pre-evaluation of the incoming data stream combined with patient historical information and information from patients with similar disease states. The pre-evaluation system may be based on data derived from working clinical practices and the records of outcomes. The derived data may be processed in a neural network, fuzzy logic system, or equivalent system to reflect the clinical practice. Further, the risk analyzer 320 may also provide means for periodic processing of present and historical data to yield a multidimensional health state indication along with disease trend prediction, next phase of disease progression co-morbidities, and/or inferences about what other possible diseases may be involved. The risk analyzer 320 may also integrate data collected from internal and external devices with subjective data to optimize management of overall patient health.

The risk analyzer 320 may also perform additional deterministic and probabilistic calculations. For example, the risk analyzer 320 may be configured to gather data related to charge levels within a given device, such as an ICD, and provide analysis and alerting functions based on this information if, for example, the charge level reaches a point at which replacement of the device and/or battery is necessary. Similarly, early degradation or imminent failure of implanted devices may be identified and proactively addressed, and/or at-risk devices may be closely monitored. In embodiments, the management platform 302 may be used as a “data clearinghouse,” to gather and integrate data collected from medical devices and/or other sources (such as, for example, one or more of the sources 304, 306, and 308, or the devices 310, 312, 314, and 316), as well as information from sources outside the health management system 300. The integrated information may be shared with other interested entities, subject to privacy restrictions, thereby increasing the quality and integration of data available.

In embodiments, the risk analyzer 320 analyzes the information received from the various information sources. For example, the risk analyzer 320 analyzes historical symptoms, diagnoses, and outcomes along with time development of the diseases and co-morbidities. In embodiments, the risk analyzer 320, the benchmark component 318, the tracking component, the care team component 324, the patient referral component 326, and/or the care planning component 328 may include machine-learning capabilities. For example, the one or more of the components 318-328 may be implemented via a neural network (or equivalent) system. One or more of the components 318-328 may be partially trained (i.e., the risk analyzer 320 may be implemented with a given set of preset values and then learn as the advanced patient management system functions) or untrained (i.e., the risk analyzer 320 may be initiated with no preset values and must learn from scratch as the advanced patient management system functions). In embodiments, one or more of the components 318—328 may continue to learn and adjust as the advanced patient management system functions (i.e., in real time), or may remain at a given level of learning and only advanced to a higher level of understanding when manually allowed to do so.

One or more of the components 318-328 may be configured to use various algorithms and mathematical modeling such as, for example, trend and statistical analysis, data mining, pattern recognition, cluster analysis, neural networks and fuzzy logic. The risk analyzer 320 may perform deterministic and probabilistic calculations. Deterministic calculations include algorithms for which a clear correlation is known between the data analyzed and a given outcome.

In addition, patient-specific clinical information may be stored and tracked for hundreds of thousands of individual patients, enabling a first-level electronic clinical analysis of the patient's clinical status and an intelligent estimate of the patient's short-term clinical prognosis. The management platform 302 may be capable of tracking and forecasting a patient's risk with increasing levels of sophistication by measuring a number of interacting co-morbidities, all of which may serve individually or collectively to degrade the patient's health. This may enable the management platform 302, as well as caregivers, to formulate a predictive medical response to oncoming acute events in the treatment of patients with chronic diseases such as heart failure, diabetes, pain, cancer, and asthma/COPD, as well as possibly head-off acute catastrophic conditions such as MI and stroke.

In embodiments, the management platform 302 includes a communication component 334 that may be configured to coordinate delivery of feedback based on analysis performed by the risk analyzer 320. For example, in response to the risk analyzer 320, the communication component 334 may manage medical devices, perform diagnostic data recovery, program the devices, and/or otherwise deliver information as needed. In embodiments, the communication component 334 can manage a web interface that can be accessed by patients and/or caregivers. The information gathered by an implanted device may be periodically transmitted to a web site that is securely accessible to the caregiver and/or patient in a timely manner (e.g., via a caregiver portal). In embodiments, a patient accesses detailed health information with diagnostic recommendations based upon analysis algorithms derived from leading health care institutions.

Embodiments of the system enable cooperative and/or collaborative risk-based payment, pricing or costing; risk-based education; risk-based monitoring; risk-based treatment; risk-based follow-up; risk-based discharge; risk-based treatment; and/or the like. Embodiments of the system may enable a user to evaluate the risk of a larger sample or population of patients, which may be valuable for budgeting and planning purposes. For example, using embodiments of the system 300, a hospital may be able to ascertain the percentages of their patients that are at different risk levels and the specific risk factor or factors contributing to the risks that their patients have. In this manner, for example, a hospital may be able to plan care more readily and efficiently for its patients.

The illustrative health management system 300 shown in FIG. 3 is not intended to suggest any limitation as to the scope of use or functionality of embodiments of the present disclosure. Neither should the illustrative health management system 300 be interpreted as having any dependency or requirement related to any single component or combination of components illustrated therein. Additionally, various components depicted in FIG. 3 may be, in embodiments, integrated with various ones of the other components depicted therein (and/or components not illustrated), all of which are considered to be within the ambit of the present disclosure. For example, any one or more of the components 318-334 may be integrated with any one or more of the other components 318-334.

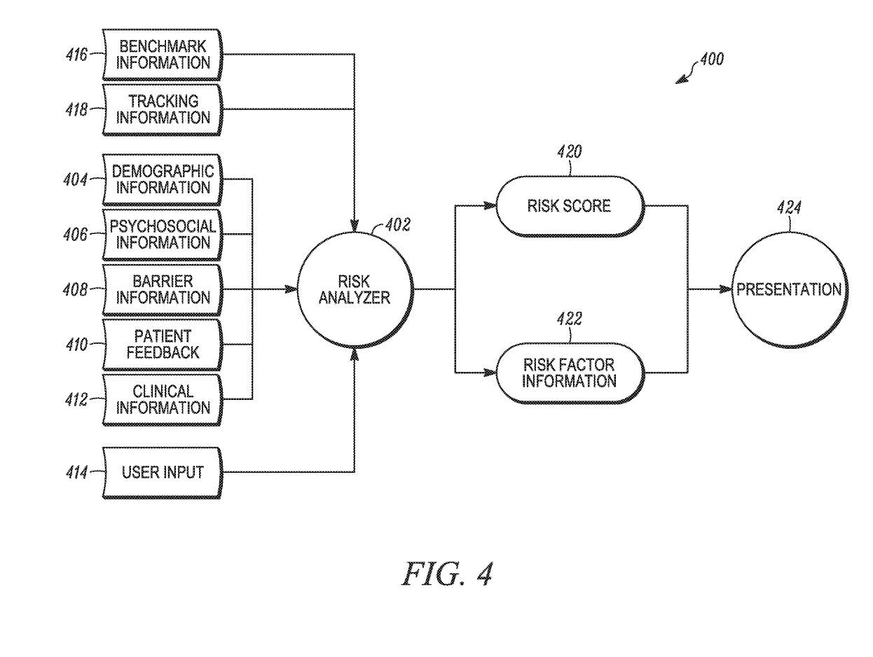

As described above, any number of various combinations of components depicted in FIG. 3 may be implemented in any number of different ways, on any number of different devices, and/or the like. FIG. 4 is a schematic diagram depicting an illustrative process flow 400 for facilitating patient health management, in accordance with embodiments of the disclosure. Because any number of the various components depicted in FIG. 4 may be implemented in any number of different combinations of devices, FIG. 4 is depicted, and described, without regard to the particular device(s) within which each component is implemented, but is rather discussed in the context of system components and their functions.

As shown in FIG. 4, a risk analyzer 402 receives, as input, patient information. That patient information may include, for example and as shown, demographic information 404, psychosocial information 406, barrier information 408, patient feedback 410, and clinical information 412. The risk analyzer 402 also may receive user input 414, benchmark information 416, tracking information 418, and/or the like. Based on at least the patient information (and, in embodiments, the user input 414, the benchmark information 416, and/or the tracking information 418), the risk analyzer 402 determines a risk score 420. The risk analyzer 402 also may identify risk factors (factors that influence the risk score), and determine a level of influence that each of the risk factors has on the risk score. According to embodiments, any number of additional types of information may be used by the risk analyzer 402 in determining risk scores, identifying risk factors, and/or determining levels of influence of risk factors. For example, in embodiments, the risk analyzer 402 may also receive operational and/or performance data from hospitals or other healthcare providers, health care study information (e.g., results from clinical studies, statistical analyses regarding populations, etc.), public records related to healthcare providers' licenses (e.g., disciplinary reports, records of convictions of crimes, license revocations and/or restrictions, etc.), and/or the like.

According to embodiments, the risk score may include a numerical value corresponding to a risk of admission, a risk of readmission, a risk of hospital utilization, a risk of high care cost, a risk of injury, a risk of decompensation, a risk of noncompliance, a risk of exacerbation of the patient's illness and/or condition, a risk of an adverse event, and/or the like. In embodiments, determining the risk score may include applying a statistical model to the patient information. The statistical model may include, for example, a regression model, a correlation model, and/or the like. In embodiments, the risk score may be determined using any number of other types of predictive models such as, for example, fuzzy logic, neural networks, graph-based models, classifiers and/or networks of classifiers, and/or the like.

According to embodiments, a risk score may be determined by using a linear regression model to calculate a value associated with a certain type of risk. As an example, a risk score corresponding to a risk of readmission may be determined by calculating a likelihood of readmission, S. For instance, a linear relationship may be used such as S=α₁Mc_{N}+α₂Ed_{N}, where the risk factors are Mc_{N}, which is a normalized medication compliance score and Ed_{N}, which is a normalized patient education completion score. The coefficients, α₁ and α₂, may be used for weighting the risk factors based on an amount of influence each has on the risk score. These weighting coefficients may be determined based on empirical evidence such as by, for example, training one or more classifiers or other machine-learning algorithms, evaluating population trend information, and/or the like.

In embodiments, the relationship between a risk (e.g., a risk of admission, a risk of readmission, a risk of hospital utilization, a risk of high care cost, a risk of injury, a risk of decompensation, a risk of noncompliance, a risk of exacerbation of the patient's illness and/or condition, a risk of an adverse event, and/or the like) and relevant risk factors, weighting coefficients, correction terms, and/or the like may be determined using healthcare study information. That is, for example, studies, research, and/or clinical trials may be conducted to evaluate the effectiveness of various healthcare solutions such as medication compliance support apps, patient education, optimized discharge processes, care planning, post discharge care planning, monitoring, and/or the like. Studies, research, and/or clinical trials may be conducted to evaluate the influence that certain risk factors have on patient outcomes. For example, trials can be conducted to compare outcomes for patients that are compliant to medication versus patients that are non-compliant to determine the influence of compliance on outcomes. Additionally or alternatively, the relationships between risks and risk factors, weighting coefficients, correction terms, and/or the like may be determined by analyzing historical information obtained from medical records, healthcare provider operations/performance information, and/or the like.

For instance, it may be determined that, for a certain patient, medical noncompliance has a much larger impact on the patient's risk of readmission than does a failure to complete a certain amount of patient education (e.g., where the patient's prescribed medication regulates a significant body function such as tachycardia). Thus, a₁ may be determined to be much higher than a₂ such as by setting a₁ to 0.75 and a₂ to 0.25. In this manner, in addition to determining a risk score, the risk analyzer 402 may be configured to determine risk factors as well as levels of influence of each risk factor. A level of influence of the medical compliance factor in the above example may be, or be based on, the value of a₁, while the level of influence of the patient education factor may be, or be based on, the value of a₂.

The risk analyzer 402 may provide the risk score 420 and risk factor information 422 to a presentation task 424. The risk factor information may include an identification of the risk factors, the levels of influence of each of the risk factors, and/or the like. The presentation task 424 may include causing a display device to present a representation of the risk score 420. According to embodiments, presenting a representation of the risk score 420 may also include presenting a representation of the risk factor information 422, or a portion thereof. The presentation task 424 may be performed, for example, by a processor that causes a display device to present the representations.

Additionally, the process 400 may be a cyclical process. That is, for example, the risk analyzer 402 may receive additional patient information 404, 406, 408, 410, and/or 412, and/or user input 414, and may use that additional information to update the risk score 420 and/or risk factor information 422. The presentation task 424 may include presenting a representation of the updated risk factor 420, which may include presenting one or more representations of updated risk factor information 422. For example, the user input 414 may include a query provided by a clinician that directs the risk analyzer 402 to update the risk score 420 based on a selected set of patient information. That is, for example, the clinician may desire to see the effect that improving a certain risk factor may have on the risk score 420 and, accordingly, may submit a query that causes the risk analyzer 402 to update the risk score 420 in a manner that isolates and/or otherwise emphasizes the influence of the certain risk factor on the risk score 420. In embodiments, the additional information may include an indication of a completed care service (e.g., an indication that the patient has completed a patient education service), updated patient information, and/or the like.

The illustrative process flow 400 shown in FIG. 4 is not intended to suggest any limitation as to the scope of use or functionality of embodiments of the present disclosure. Neither should the illustrative process flow 400 be interpreted as having any dependency or requirement related to any single component or combination of components illustrated therein. Additionally, various components depicted in FIG. 4 may be, in embodiments, integrated with various ones of the other components depicted therein (and/or components not illustrated), all of which are considered to be within the ambit of the present disclosure.

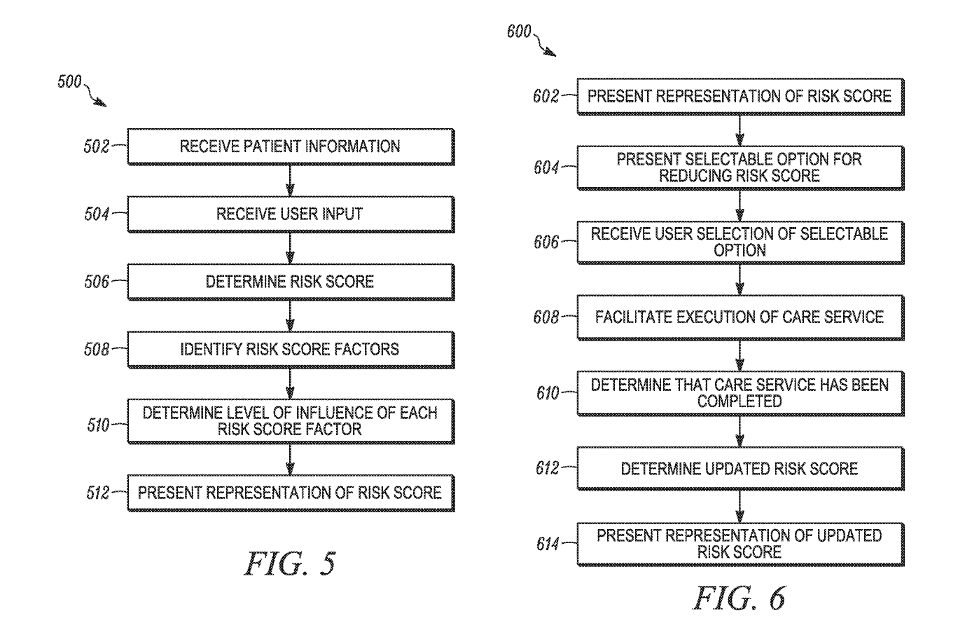

According to embodiments, systems discussed herein may facilitate health management of a patient. FIG. 5 is a flow diagram depicting an illustrative method 500 of facilitating health management of a patient, in accordance with embodiments of the disclosure. Aspects of embodiments of the illustrative method 500 may be performed by any number of different components discussed above with regard to FIGS. 1-4. As shown in FIG. 5, embodiments of the method 500 include receiving patient information (block 502). The patient information may include clinical information and at least one of psychosocial information, experiential information, relational information, preferential information, demographic information, barrier information, and compliance information.

Embodiments of the method 500 further include receiving user input (block 504). The user input may include, for example, a user query, patient feedback, selection of a selectable option for reducing a risk score (e.g., by facilitating a care service), and/or the like. The method 500 also includes determining, based on the patient information, a risk score (block 506). The risk score may be determined based on other information in addition to the patient information such as, for example, the user input, benchmark information, tracking information, and/or the like. The risk score may include a score corresponding to at least one of a risk of admission, a risk of readmission, a risk of hospital utilization, a risk of high care cost, a risk of injury, a risk of decompensation, a risk of noncompliance, a risk of exacerbation of the patient's illness and/or condition, a risk of an adverse event, and/or the like. In embodiments, determining the risk score includes applying a statistical regression model to the patient information.

Embodiments of the method 500 also include identifying risk factors (block 508); and determining a level of influence that each of the risk factors has on the risk score (block 510). As depicted in FIG. 5, embodiments of the method 500 include presenting a representation of the risk score (block 512). In embodiments, the step of presenting the representation of the risk score may be performed by causing a display device to present the representation. The representation of the risk score may include, for example, a risk indicator having at least one indication component, where a characteristic of the at least one indication component corresponds to at least one of the risk factors. According to embodiments, a representation of a risk score may include a number, a graph, a graphical representation, an image, and/or the like.

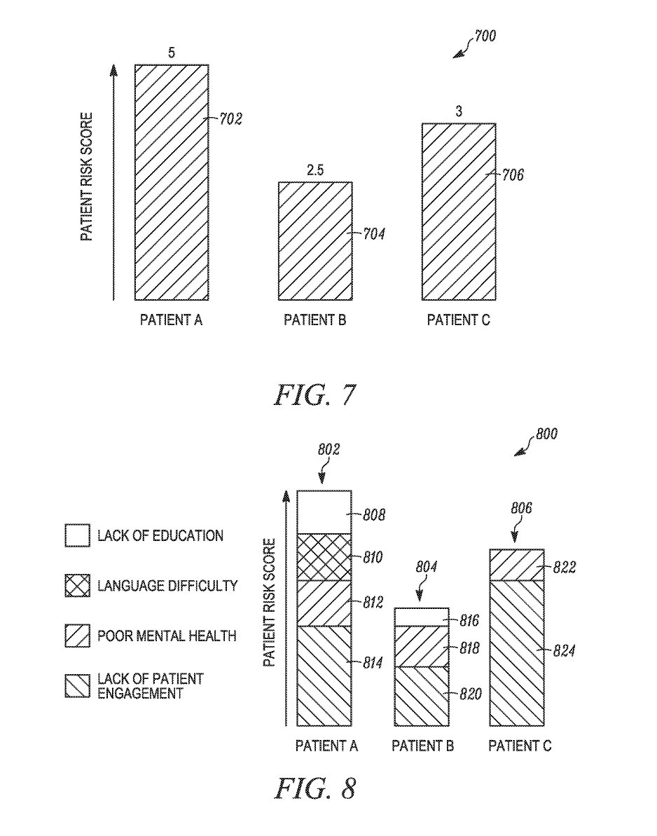

FIGS. 7 and 8 depict illustrative examples of representations of risk scores. As shown in FIG. 7, a graph 700 includes a representation 702 of a risk score associated with a first patient (Patient A), a representation 704 of a risk score associated with a second patient (Patient B), and a representation 706 of a risk score associated with a third patient (Patient C). The representations 702, 704, and 706 each include a bar having a height that is proportional to the relative magnitude of the corresponding risk score (e.g., in comparison with the other two risk scores). As shown, each risk score is also represented by a numeral, displayed within the corresponding bar, which depicts the magnitude of the risk score.

FIG. 8 depicts representations 802, 804, and 806, respectively, of the risk scores depicted in FIG. 7. The representations of risk scores depicted in FIG. 8 include risk factor information. That is, for example, a first representation 802 of the risk score associated with Patient A includes a first indication component 808 corresponding to a first risk factor (lack of education), a second indication component 810 corresponding to a second risk factor (language difficulty), a third indication component 812 corresponding to a third risk factor (poor mental health), and a fourth indication component 814 corresponding to a fourth risk factor (lack of patient engagement). The second representation 804 includes a first indication component 816 corresponding to the first risk factor, a second indication component 818 corresponding to the third risk factor, and a third indication component 820 corresponding to the fourth risk factor. The third representation 806 includes a first indication component 822 corresponding to the third risk factor and a second indication component 824 corresponding to the fourth risk factor. In this manner, a user may be able to ascertain, based on the size, color, or other characteristic of each indication component 808, 810, 812, 814, 816, 818, 820, 822, and 824. Although the examples depicted in FIGS. 7 and 8 are vertical bar graphs, any number of other types of graphical representations may be used to present risk scores (which may include presenting risk factor information).

FIG. 6 is a flow diagram depicting an illustrative method 600 of facilitating health management of a patient, in accordance with embodiments of the disclosure. As shown in FIG. 6, the illustrative method 600 includes presenting a representation of a risk score (block 602). As indicated above, the representation of the risk score may include, for example, a risk indicator having at least one indication component, where a characteristic of the at least one indication component corresponds to at least one of the risk factors. Embodiments of the method 600 also include presenting a selectable option for reducing the risk score (block 604). As shown in FIG. 6, the method 600 includes receiving, via a user input device, a user selection of the selectable option (block 606); and facilitating, in response to receiving the user selection of the selectable option, execution of a care service (block 608).

Embodiments of the method 600 further include determining that the care service has been completed (block 610). Based on determining that the care service has been completed, an updated risk score may be determined (block 612); and a representation of the updated risk score may be presented (block 614). For example, in embodiments, the representation of the risk score comprises a risk indicator having at least one indication component, where a characteristic of the at least one indication component corresponds to at least one of the risk factors. In these embodiments, causing the display device to present a representation of the updated risk score may include, for example, assigning, based on the risk score, a first value of the characteristic of a first indication component, wherein causing the display device to present a representation of the risk score comprises causing the display device to present the first indication component having the first value of the characteristic; and assigning, based on the updated risk score, a second value of the characteristic of the first indication component, wherein causing the display device to present a representation of the updated risk score comprises causing the display device to present the first indication component having the second value of the characteristic. In embodiments, causing the display device to present a representation of the updated risk score may further include assigning, based on the risk score, a third value of the characteristic of a second indication component, wherein causing the display device to present a representation of the risk score comprises causing the display device to present the second indication component having the third value of the characteristic. In embodiments, the characteristic may include color, activation state (e.g., whether a light or image is illuminated or otherwise presented), intensity (e.g., in the case of color or light), transparency, and/or the like.

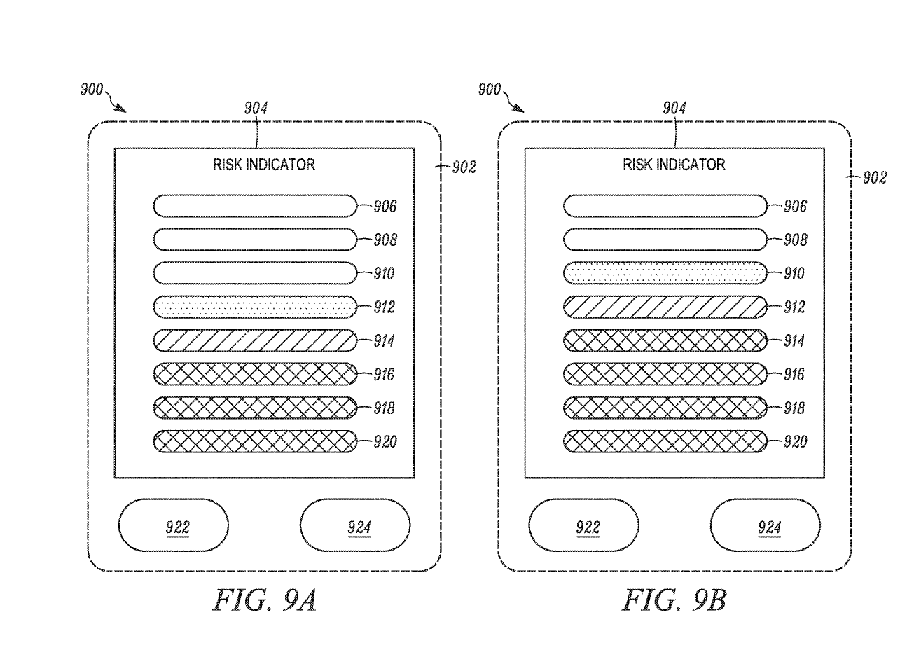

As an illustrative example of embodiments of the method 600 described above, FIGS. 9A and 9B depict illustrative screenshots of a user interface 900 that includes a display region 902 in which a risk indicator 904 is presented. As shown, the risk indicator 904 includes indication components 906, 908, 910, 912, 914, 916, 918, and 920. In embodiments, each of the indication components 906-920 may correspond to a risk factor. Each of the indication components 906-920 may be configured to be illuminated (e.g., filled with a certain color in a manner similar to a battery-life indicator and/or wireless reception quality indicator). In embodiments, for example, a risk score may be represented by the number of indication components 906—920 that are illuminated, the color of the indication components 906-920, and/or the like. For example, the more indication components 906-920 that are illuminated, the lower the risk score may be, while fewer illuminated indication component 906-920 may indicate a higher risk score.

Additionally, individual indication components 906-920 may be filled with a color representing an influence level of a particular risk factor. That is, for example, an indication component 906-920 may be colored red if the corresponding risk factor has an influence level that exceeds a first threshold, orange if the corresponding risk factor has an influence level that is less than the first threshold but greater than a second threshold, green if the corresponding risk factor has an influence level that is lower than the second threshold but higher than a third threshold, and white (or shown as empty or not illuminated) if the corresponding risk factor has an influence level that is lower than the third threshold. Any number of other coloring schemes, indication component shapes and/or configurations, and/or the like may be utilized to represent risk scores.

In embodiments, the risk indicator 904 may be presented on a patient's access device (e.g., a mobile device, a tablet, a laptop, a desktop, etc.). In this manner, embodiments of systems and methods described herein may facilitate incentivizing the patient to engage in behaviors that reduce the patient's risk (e.g., a risk of admission, a risk of readmission, a risk of hospital utilization, a risk of high care cost, a risk of injury, a risk of decompensation, a risk of noncompliance, a risk of exacerbation of the patient's illness and/or condition, a risk of an adverse event, and/or the like). According to embodiments, the user interface 900 may include one or more selectable options 922 and 924 for reducing the risk score. The selectable options 922 and 924 may be configured to be selectable by a user (via a user input device such as, for example, a mouse, a touchscreen, etc.). In response to receiving the user selection, a processor (e.g., a processor on the user access device and/or a processor associated with a management platform) may be configured to facilitate providing a care service to the user. The user may be the patient, a healthcare provider, and/or the like. The care service may include, for example, a remote monitoring service (e.g., the patient could be monitored via remote patient monitoring), a care transition program, follow-up post discharge with a home visit or a phone call, an optimized or re-engineered discharge program, home delivery of prescribed medication, telehealth services such as video consultations with a physician post discharge, translation services (e.g., a patient and/or healthcare provider could be provided with an interpreter to assist with language differences), referral services (e.g., the patient could be referred to a specialist such as a nutritionist, psychologist, occupational therapist, etc.), a reminder service that provides reminders and/or motivational statements to the patient via a messaging application (e.g., SMS) or email to promote compliance or beneficial lifestyle/behavioral change.

For instance, patient education may be a care service that may be provided to a patient that is at high risk due to the fact that they do not understand their condition and/or do not understand the purpose of prescribed medication. By identifying the influence of lack of education on the patient's risk score, the management platform (or, in embodiments, a local client application) may determine that the patient's risk score can be improved by providing patient education.

In embodiments, the type, extent, and/or level of education indicated may also be determined based on other risk factors and/or patient information. For example, if patient education is a significant risk factor for the patient, it may be worth giving that patient a more expensive or premium “education” intervention with one-on-one, face-to-face teaching sessions using the Teach-Back Method, and/or the like. The Teach-Back Method is a communication confirmation method used by healthcare providers to confirm whether a patient (or caregiver) understands what is being explained to them. That is, if a patient or caregiver understands, they are able to “teach-back” the information accurately. For another patient, where the influence of that same risk factor is lower, it may be of more value to provide a low-touch education solution and to focus on addressing alternative risk factors such as, for example, the patient's difficulty with on-time collection of their medication prescription from a pharmacy.

According to embodiments, the management platform (or other application) may be configured to consider other patient information such as, for example, cognitive ability, before prescribing a specific education care service. For example, by completing a basic education module, a patient with strong cognitive ability may only improve their risk score by 50% of the improvement realized by a patient of lower cognitive ability completing the same education module. In embodiments, upon receiving user selection of a selectable option corresponding to an education module, the educational materials may be presented to the patient via a hyperlinked website, sent to the patient via email, and/or the like. Completion of the education module may be verified in any number of ways such as, for example, by administering a quiz, requesting that the patient certify that they have completed the module, and/or the like.

In embodiments, the user interface 900 may be configured to present information to the patient that informs the patient that completion of a care service (e.g., a patient education module) will improve the patient's risk score by an amount that results in illumination of one additional indication component, changing an indication component from one color to another (e.g., from red to orange), and/or the like; while completion of a different care service and/or demonstration of a certain behavior (e.g., demonstrating medication compliance over a certain number of days) may improve the patient's risk score by an amount that results in illumination of two additional indication components, changing an indication component from the first color (e.g., red) to a different second color (e.g., green), and/or the like. Thus, as shown in FIG. 9B, in response to completion of a care service or demonstration of a behavior, the indication components 908 and 910 have been illuminated to represent the corresponding improvement in the patient's risk score. In this manner, responsibility for health maintenance may be partially transferred to the patient.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A method of facilitating health of a patient, the method comprising:
determining, based on patient information, a risk score, the patient information comprising clinical information and at least one of psychosocial information, experiential information, relational information, preferential information, demographic information, barrier information, and compliance information;
identifying a plurality of risk factors that influence the risk score;
determining a level of influence that each of the plurality of risk factors has on the risk score; and
causing a display device to present a representation of the risk score.

2. The method of claim 1, wherein the representation of the risk score includes a representation of the level of influence of each of the plurality of risk factors.

3. The method of claim 1, further comprising:
receiving additional patient information and/or user input; and
determining, based on the additional patient information and/or the user input, an updated risk score; and
causing the display device to present a representation of the updated risk score.

4. The method of claim 1, further comprising generating, based on at least one of the risk score and the updated risk score, a recommendation, the recommendation comprising at least one of a care team recommendation and a care plan recommendation.

5. The method of claim 1, the risk score comprising a score corresponding to at least one of a risk of admission, a risk of readmission, a risk of hospital utilization, a risk of high care cost, a risk of injury, a risk of decompensation, a risk of noncompliance, a risk of exacerbation, and a risk of an adverse event.

6. The method of claim 1, wherein determining the risk score comprises applying a statistical regression model to the patient information.

7. The method of claim 1, wherein the representation of the risk score comprises a risk indicator, the risk indicator comprising at least one indication component, wherein a characteristic of the at least one indication component corresponds to at least one of the plurality of risk factors.

8. The method of claim 1, further comprising:
causing the display device to present a selectable option for reducing the risk score;
receiving, via a user input device, a user selection of the selectable option;
facilitating, in response to receiving the user selection of the selectable option, execution of a care service;
determining that the care service has been completed;
determining, based on determining that the care service has been completed, an updated risk score; and
causing the display device to present a representation of the updated risk score.

9. The method of claim 8, the care service comprising an education module, and wherein determining that the care service has been completed comprises determining that the patient has completed the education module.

10. The method of claim 8, wherein causing the display device to present a representation of the updated risk score comprises:
assigning, based on the risk score, a first value of the characteristic of a first indication component, wherein causing the display device to present a representation of the risk score comprises causing the display device to present the first indication component having the first value of the characteristic; and
assigning, based on the updated risk score, a second value of the characteristic of the first indication component, wherein causing the display device to present a representation of the updated risk score comprises causing the display device to present the first indication component having the second value of the characteristic.

11. The method of claim 10, wherein causing the display device to present a representation of the updated risk score further comprises:
assigning, based on the risk score, a third value of the characteristic of a second indication component, wherein causing the display device to present a representation of the risk score comprises causing the display device to present the second indication component having the third value of the characteristic.

12. The method of claim 10, wherein the characteristic comprises color and/or activation state.

13. A system for facilitating health of a patient, the system comprising:
a display device;
at least one processor; and
one or more computer-readable media having computer-executable instructions embodied thereon that, when executed by the at least one processor, cause the at least one processor to instantiate at least one program component, the at least one program component comprising a risk analysis component configured to:
determine, based on patient information, a risk score, the patient information comprising clinical information and at least one of psychosocial information, experiential information, relational information, preferential information, demographic information, barrier information, and compliance information;
identify a plurality of risk factors that influence the risk score;
determine a level of influence that each of the plurality of risk factors has on the risk score; and
cause the display device to present a representation of the risk score.

14. The system of claim 13, further comprising:
a care team component configured to generate, based on at least one of the risk score and the updated risk score, a care team recommendation; and/or
a care planning component configured to generate, based on at least one of the risk score and the updated risk score, a care plan recommendation.

15. The system of claim 13, the risk score comprising a score corresponding to at least one of a risk of admission, a risk of readmission, a risk of hospital utilization, a risk of high care cost, a risk of injury, a risk of decompensation, a risk of noncompliance, a risk of exacerbation, and a risk of an adverse event.

16. The system of claim 13, wherein determining the risk score comprises applying a statistical regression model to the patient information.

17. The system of claim 13, wherein the representation of the risk score comprises a risk indicator, the risk indicator comprising at least one indication component, wherein a characteristic of the at least one indication component corresponds to at least one of the plurality of risk factors.

18. The system of claim 13, further comprising:
causing the display device to present a selectable option for reducing the risk score;
receiving, via a user input device, a user selection of the selectable option;
facilitating, in response to receiving the user selection of the selectable option, execution of a care service;
determining that the care service has been completed;
determining, based on determining that the care service has been completed, an updated risk score; and
causing the display device to present a representation of the updated risk score.

19. One or more computer-readable media having computer-executable instructions embodied thereon that, when executed by the at least one processor, cause the at least one processor to instantiate at least one program component, the at least one program component comprising:
a risk analysis component configured to:
determine, based on patient information, a risk score, the patient information comprising clinical information and at least one of psychosocial information, experiential information, relational information, preferential information, demographic information, barrier information, and compliance information;
identify a plurality of factors that influence the risk score;
determine a level of influence that each of the plurality of factors has on the risk score; and
cause the display device to present a representation of the risk score.

20. The media of claim 19, the risk score comprising a score corresponding to at least one of a risk of admission, a risk of readmission, a risk of hospital utilization, a risk of high care cost, a risk of injury, a risk of decompensation, a risk of noncompliance, a risk of exacerbation, and a risk of an adverse event.
